(19) United States
(12) Patent Application Publication
(10) Pub. No.: US 2006/0009551 A1
(43) Pub. Date: Jan. 12, 2006

(54) Asphalt-rubber material for pedestrian and bicycle trails

(76) Inventors: Robert C. Amme, Centennial, CO (US); William B. Meggison, Brush, CO (US); Haifeng Ni, Lincoln, NE (US)

Correspondence Address: DORR CARSON SLOAN & BIRNEY, PC, 3010 EAST 6TH AVENUE, DENVER, CO, 80206, US

(21) Appl. No.: 11/175,697

(22) Filed: Jul. 6, 2005

Related U.S. Application Data
(60) Provisional application No. 60/585,699, filed on Jul. 6, 2004.

(51) Int. Cl. C08L 95/00

(52) U.S. Cl. 524/59

(57) ABSTRACT

A paving material suitable for pedestrian and bicycle trails combines an asphalt-rubber binder and crumb rubber aggregate. The binder is approximately 15%-30% finely divided recycled tire rubber and approximately 70%-85% asphalt by weight. Additives can be included to increase chemical bonding between the asphalt and rubber. The crumb rubber aggregate can be ground tire rubber. In the preferred embodiment, the asphalt-rubber binder and crumb rubber aggregate are combined in a roughly even ratio by weight, although the proportion of binder could vary from approximately 40% to 60%.

### RELATED APPLICATION

The present application is based on, and claims priority to the Applicants' U.S. Provisional Patent Application Ser. No. 60/585,699, entitled “Asphalt-Rubber Material for Pedestrian and Bicycle Trails”, filed on Jul. 6, 2004.

### BACKGROUND OF THE INVENTION

1. Field of the Invention

The present invention relates generally to the field of asphalt rubber compositions. More specifically, the present invention discloses an asphalt-rubber composition with crumb rubber aggregrate that is suitable for pedestrian and bicycle trails.

2. Statement of the Problem

The present invention is intended to address two concerns. The first problem involves the accumulation of used tires in landfills, dumps, and recycling facilities, due to the lack of an adequate market for recycled rubber. Some used tires are incinerated or used to fuel power plants. Also, some recycled rubber is used to produce building materials. However, disposal of used tires remains a significant problem.

The second problem arises from the need for softer, more resilient materials for pedestrian and bicycle trails. There is considerable evidence that walkers, joggers, and runners prefer a softer, more resilient surface than common concrete or asphalt pathways. The present inventors have tested mats made from recycled tire rubber, as well as asphalt-based materials to which crumb rubber and stone have been added. Both type materials have received much higher ratings by users than have their firmer, but traditional counterparts. What is needed is a material, preferably containing recycled tire rubber, that is durable, well-secured to the surface, and resilient enough to reduce the shock to the feet, ankles, shins, and knees of joggers and runners. The material could also find application as an improved surface for playgrounds. The material should best be resistant to water penetration or uptake (i.e., have lower permeability). The material should be wear-resistant and have a lifetime of at least ten years under normal outdoor conditions. While the surface might normally appear black, coloration of the material should be an option in order to blend in better with the natural environment, if desired.

3. Prior Art in the Field

Rubberized asphalt paving has long been used on vehicular roadways. Rubberized asphalt typically uses a “wet mix” method in which reclaimed tire rubber is finely divided and blended with asphalt to form the binder. For example, the binder can be approximately 20% rubber and 80% asphalt by weight. The binder is then combined with stone (or crushed rock) aggregate, usually ¾ inch in diameter and below. This asphalt-rubber (or AR) paving is an improvement over ordinary asphalt paving, which contains no rubber additive. The AR binder itself is generally under 10% of the total weight of the mix, and the rubber additive therefore constitutes only about 2% of the total mix. Roughly 90% by weight of this material is still crushed rock or stone. It does offer improved tensile strength, elasticity and ductility, with improved temperature characteristics and a reduced susceptibility to cracking. However, conventional AR pavings create a hard surface, primarily for vehicular traffic. This is not particularly pleasing to pedestrians. Nevertheless, a large percentage of paved pedestrian trails consist either of traditional asphalt or concrete.

The prior art in this field also includes a variety of paving materials that create a crumb rubber surface using binders, such as polyurethane, latex, or proprietary adhesives. These materials are typically quite expensive. The result is that such materials are commonly used only to cover relatively small areas, such as tennis courts, running tracks, mats, and other relatively short stretches on the order of a quarter mile or less in length.

4. Solution to the Problem

The present invention addresses the shortcomings of the prior art by providing a paving material suitable for pedestrian and bicycle trails that uses an asphalt-rubber binder and crumb rubber aggregate. This material is resilient, durable, and water-resistant. In addition, it provides a market for the cost-effective recycling of used tires.

### SUMMARY OF THE INVENTION

This invention provides a paving material suitable for pedestrian and bicycle trails that combines an asphalt-rubber binder and crumb rubber aggregate. In particular, the binder is approximately 15%-30% finely divided recycled tire rubber and approximately 70%-85% asphalt by weight. Additives can be included to increase chemical bonding between the asphalt and rubber. The crumb rubber aggregate can be ground tire rubber. In the preferred embodiment, the asphalt-rubber binder and crumb rubber aggregate are combined in a roughly even ratio by weight, although the proportion of binder could vary from approximately 40% to 60%.

These and other advantages, features, and objects of the present invention will be more readily understood in view of the following detailed description and the drawings.

### BRIEF DESCRIPTION OF THE DRAWINGS

The present invention can be more readily understood in conjunction with the accompanying drawings, in which:

FIG. 1 is a flowchart illustrating a method of paving in accordance with the present invention.

FIG. 2 is a flowchart illustrating a second method of paving using the present invention.

FIG. 3 is a flowchart illustrating a third method of paving using the present invention.

### DETAILED DESCRIPTION OF THE INVENTION

The present invention involves the use of asphalt-rubber (AR) binder as described above in a “wet mix” process, in which finely-divided tire rubber is blended with asphalt to form the binder. The binder composition may vary from the conventional 20%-80% ratio of tire rubber to asphalt cement. For example, the binder may vary from approximately 15% to 30% rubber. In the preferred embodiment, the rubber and asphalt are mixed at a temperature of approximately 375° F. to 400° F. using an auger blender for at least an hour.

Optionally, chemical modifiers can be included in the binder. For example, polyoctenamer additives such as the VESTENAMER® additive sold by Degussa AG of Dusseldorf, Germany, cause a chemical reaction that enhances bonding between the rubber and asphalt. This increases strength, stiffness, and fracture resistance to low temperature cracking, and reduces surface tackiness. For example, approximately 3%-5% polyoctenamer additive has been found to be suitable of this purpose. However, such additives increase the cost of the composition.

In the preferred embodiment of the present invention, crumb rubber is used as aggregate, rather than stone or rock. For example, the crumb rubber aggregate can be ground tire rubber having a diameter of about ⅛ to ⅜ inch (i.e., approximately 10-mesh to 4-mesh sieve size). Of course, other sizes may work as well, and there are economic tradeoffs on the grind size. The applicants have also successfully experimented with ground tire rubber having approximately 20-mesh sieve size (approximately 95% between 14-mesh to 30-mesh sieve size).

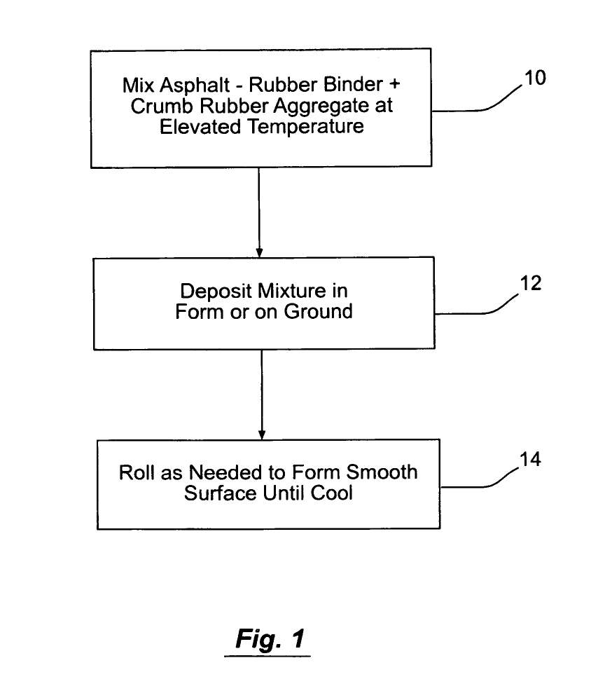

A variety of different techniques can be employed to combine the asphalt-rubber binder and crumb rubber aggregate, and to pave the finished trail. For example, as shown in FIG. 1, the binder and aggregate can be mixed at an elevated temperature (step 10) and then deposited in a form or on the ground to create a trail (step 12). In one embodiment, the asphalt-rubber binder and crumb rubber aggregate are combined in a roughly even ratio by weight, although the proportion of binder could vary from approximately 40% to 60%. While cooling, the paving material can be rolled (e.g., with a rubber-tire compactor) to form a relatively smooth surface (step 14).

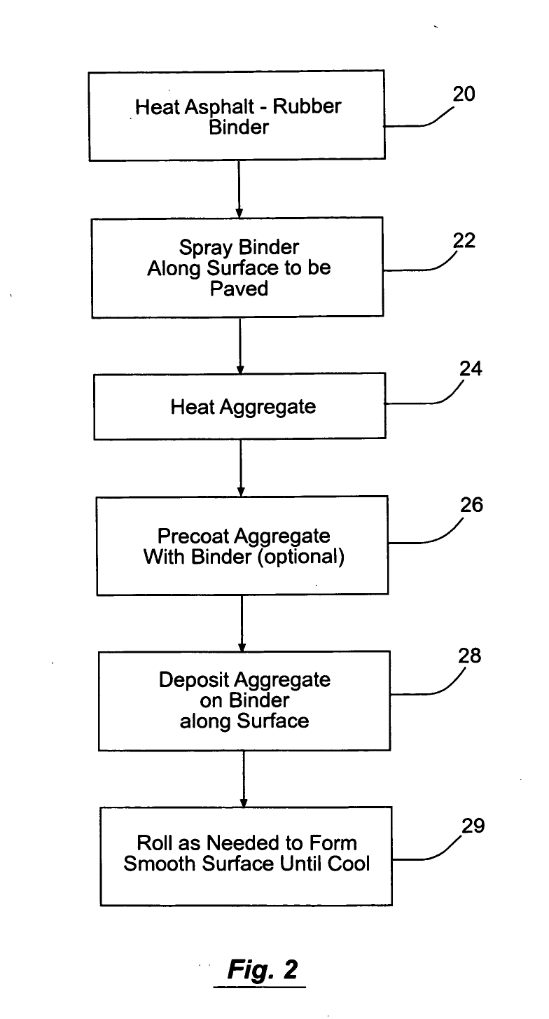

In a second technique shown in FIG. 2, the binder is heated (step 20) and sprayed or otherwise deposited in a layer along the desired area to be paved (e.g., a trail) (step 22). The aggregate is also heated (step 24) and may optionally be precoated with binder (step 26). A layer of aggregate is then deposited on the binder along the trail (step 28). While cooling, the material is then rolled and compacted (step 29).

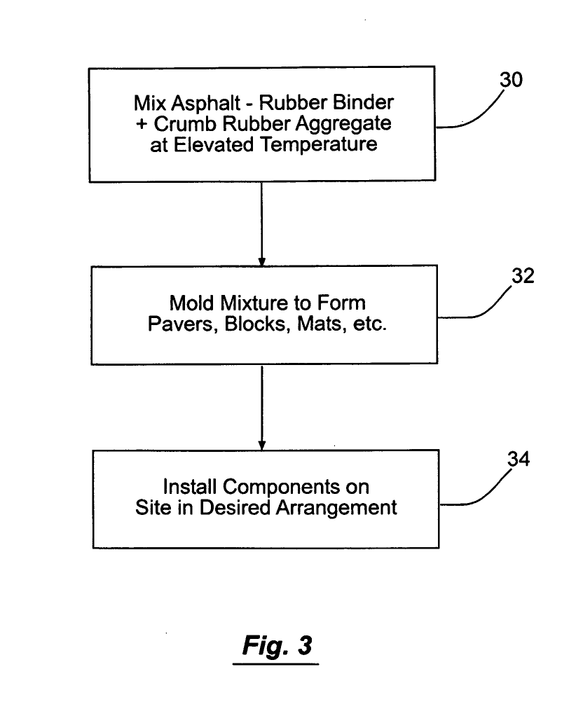

In a third technique illustrated in FIG. 3, the binder and aggregate are heated and combined (step 30), and molded off-site to form components of a desired shape (e.g., pavers, blocks, mats, or panels) (step 32). These components can be readily transported to the work site for installation in any desired arrangement (step 34).

The resulting product is flexible, more compressible and resilient, and thus easier on the walker's or runner's anatomy. The thickness of the application will depend on a number of factors, including the condition or nature of the subsurface, water drainage concerns, cost limitations, desired lifetime and intended use, etc. We also foresee multiple-use trails with one side designed principally for walker or joggers, and the other for bicycles or other types of traffic.

If a firmer surface is desired for greater strength, but less flexibility, a suitable blend of stone and crumb rubber can be employed as the aggregate. This embodiment would still be more resilient than conventional paving materials made from stone aggregate, and might be suitable for use in situations where occasional vehicular traffic is anticipated, such as for snow removal, spraying, sweeping, maintenance, and the like.

The above disclosure sets forth a number of embodiments of the present invention described in detail with respect to the accompanying drawings. Those skilled in this art will appreciate that various changes, modifications, other structural arrangements, and other embodiments could be practiced under the teachings of the present invention without departing from the scope of this invention as set forth in the following claims.

We claim:

1. A paving material comprising:
a binder including a mixture of finely-divided recycled tire rubber and asphalt; and
crumb rubber aggregate.

2. The paving material of claim 1 wherein recycled tire rubber comprises approximately 15% to 30% of the binder.

3. The paving material of claim 1 wherein asphalt comprises approximately 70% to 85% of the binder.

4. The paving material of claim 1 wherein the binder further comprises a polyoctenamer additive.

5. The paving material of claim 1 wherein the binder comprises approximately 40% to 60% of the paving material.

6. The paving material of claim 1 wherein the crumb rubber aggregate comprises ground recycled tire rubber.

7. The paving material of claim 1 wherein the crumb rubber aggregate has a size of approximately ⅛ inch to ⅜ inch.

8. A paving method comprising:
heating and mixing crumb rubber aggregate with a binder including a mixture of finely-divided recycled tire rubber and asphalt;
depositing the mixture over an area to be paved; and
rolling the mixture to form a smooth surface.

9. The method of claim 8 wherein recycled tire rubber comprises approximately 15% to 30% of the binder.

10. The method of claim 8 wherein asphalt comprises approximately 70% to 85% of the binder.

11. The method of claim 8 wherein the binder comprises approximately 40% to 60% of the paving material.

12. The paving material of claim 8 wherein the crumb rubber aggregate comprises ground recycled tire rubber.

13. A paving method comprising:
heating a binder that includes a mixture of finely-divided recycled tire rubber and asphalt;
depositing a layer of the heated binder over an area to be paved;
heating crumb rubber aggregate;
depositing the heated aggregate on the binder layer;
rolling the surface of the resulting mixture of binder and aggregate.

14. The method of claim 13 wherein recycled tire rubber comprises approximately 15% to 30% of the binder.

15. The method of claim 13 wherein asphalt comprises approximately 70% to 85% of the binder.

16. The method of claim 13 wherein the binder comprises approximately 40% to 60% of the paving material.

17. The paving material of claim 13 wherein the crumb rubber aggregate comprises ground recycled tire rubber.

18. A paving method comprising:
heating and mixing crumb rubber aggregate with a binder that includes a mixture of finely-divided recycled tire rubber and asphalt;
molding the mixture to form components of a desired shape and allowing the mixture to cool; and
installing components in an arrangement to pave a desired area.

19. The method of claim 18 wherein the crumb rubber aggregate comprises ground recycled tire rubber.

20. The method of claim 18 wherein recycled tire rubber comprises approximately 15% to 30% of the binder.
